(19) United States
(12) Patent Application Publication
(10) Pub. No.: US 2008/0163199 A1
(43) Pub. Date: Jul. 3, 2008

(54) MULTI-PRODUCT PACKAGE CREATION AND EDITING

(76) Inventors: Siddhartha Ashok RAO, Sandhausen (DE); Mairon F. H. HOLGER, Muehlhausen (DE)

Correspondence Address: KENYON & KENYON LLP, 1500 K STREET N.W., WASHINGTON, DC, 20005, US

(21) Appl. No.: 11/618,797

(22) Filed: Dec. 30, 2006

(51) Int. Cl. G06F 9/445

(52) U.S. Cl. 717/177

(57) ABSTRACT

A system and method for creation and installation of a software package containing multiple applications, products and/or parts thereof. The system and method involve identifying applications available on a server for distribution to at least one user workstation, selecting multiple applications, associating the multiple applications in a manner so as to form a software package, and installing the software package containing the multiple applications on the user workstation(s) as a result of a single request.

A business system may include a variety of software applications that can be installed on user computers to allow users to perform operations within the business system. Each software application generally includes an installation application, which when run on a computer configures the software application on the computer. Since a business system may include a large number of software applications, many such installations may be required to property configure a computer before it can be used in the business system. When a previously-installed software application is to be replaced by an updated version of the application, the previous version often must be removed from the computer prior to installation of the new version. Software applications may rely on other applications, requiring the applications to be installed in a particular order.

### BRIEF DESCRIPTION OF THE DRAWINGS

FIG. 1 shows a system and method for creating a multi-product installation package according to an embodiment of the present invention.

FIG. 2 shows a system for installing an application package on user workstations according to an embodiment of the present invention.

FIG. 3 shows a method for creating and using an application package according to an embodiment of the present invention.

FIG. 4 shows a user interface for installing applications according to an embodiment of the present invention.

FIG. 5 shows a user interface for installing application packages according to another embodiment of the present invention.

FIG. 6 shows a user interface for installing application packages according to another embodiment of the present invention.

### DETAILED DESCRIPTION

The present invention provides a system and method allowing an administrator of a business system to prepare installation packages containing multiple software products. A distribution or installation server may store the files and configuration information required to install a software product on a user workstation. When an administrator accesses the distribution server, the distribution server may present a list of available software applications. By selecting one or more of the available applications, an administrator may create an installation package from a group of software products. When a user later runs an installation application on a workstation, the installation application may present a list of the packages created by the administrator of the installation application. For example, the administrator may create software packages based on user roles or departments, such as human resources, engineering, quality control, managers, etc. When a, for example, local administrator or user runs the installation application, he may select the appropriate software package, such as a package designed for his role or the department to which he is assigned.

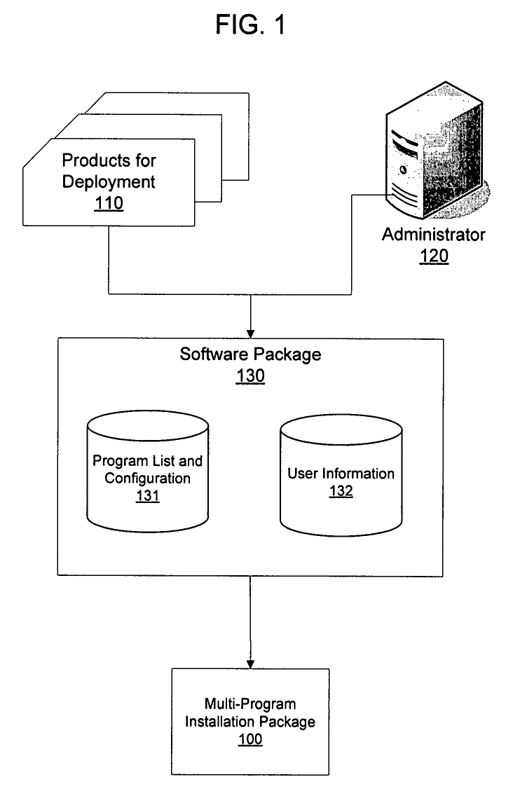

FIG. 1 shows a system and method according to an embodiment of the present invention. Software applications for deployment, or programs or products, 110 may be stored in a business system. The software applications 110 may be stored, for example, on a distribution server in communication With other servers and workstations in the business system. The applications may be stored and accessed using various storage devices and computer systems available. Unless specified otherwise herein, the specific topology of servers, workstations, and communication protocols of the various individual components of the present invention and systems used with the present invention are irrelevant to the present invention, and any such topology and communications as are available may be used with the present invention. The software applications 110 are each available for deployment. Each software application may be contained on the distribution server as an individually deployable unit, and, according to the present invention, as a collectively deployable unit. An administrator 120 may access the software applications in the business system. For example, a distribution server may present a list of software applications available in the business system to the administrator 120. By selecting desired applications, the administrator may construct a software package 130. The software package may be, for example, a set of commonly-used applications, a set of applications intended for use by a specific group of users or users having a specific role within the business system, a set of applications used with or intended for a specific type of task, or any other desired group of applications. The software package 130 may include a application listing and configuration information for the selected applications 131, this data may be stored, for example, in a database, an XML file, or other appropriate storage mechanism. The software package 130 allows, e.g., for an administrator, that multiple software applications may be collected in a group. Each of the software applications may include customizing of its installation parameters such as location address, proxy address, user name, password. The customizing can be of any installation parameters desired and not only those mentioned here for illustrative purposes. The multi-product, or multi-application, package may allow for the maintenance of all products in the package as a single unit on the user, or end-user, workstation.

In an embodiment of the present invention, a system available on a multi-product distribution server may contain products available for deployment, where each product is an individually deployable unit. The products may be organized, according to the present invention, as a collectively deployable unit. A multi-product package may allow an administrator to collect multiple products “under one roof.” The installation parameters may be customized in advance. And, an administrator may be allowed to maintain the products as a unit on the end user workstation, as opposed to maintaining each individual product. This provides a more manageable solution to time efficiency for an administrator.

If the software package 130 is intended for use by a specific group or type of user, the software package 130 may also include user information 132. For example, it may include a list of users authorized to access the software package 130. Other user information or customizing information discussed above may be stored or associated with the software package 130. Once an administrator creates a software package 130, it may be provided to users as a multi-product installer 100. The installer 100 may allow a user to install the software applications 110 selected by an administrator for inclusion in the software package 130.

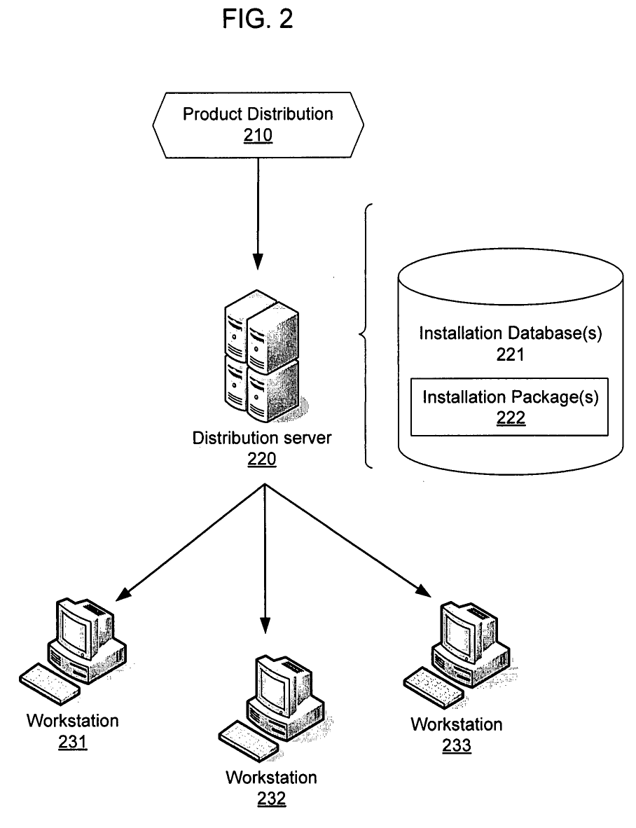

FIG. 2 shows how multiple software applications may be distributed to user workstations in a business system. A software application is received from the distributor 210. The software application may be distributed, for example, via optical media, network delivery, or other distribution methods available. The software application may be stored on a distribution server 220. The distribution server 220 may store data and configuration information to install various multiple software applications on user workstations 231, 232, 233. For example, the application installation data and/or configuration information may be stored in various application databases 221. When used with the present invention, the distribution server may also store and manipulate installation packages 222. Each of the installation packages 222 may be created, for example, using the embodiment process according to FIG. 1. The distribution server may provide information about the installation packages 222 to the user workstations 231, 232, 233 to allow a user to select pre-configured software packages to be installed on its workstation. In a further embodiment, the multiple software packaging and distribution may occur automatically based on a pre-established database and corresponding execution instruction.

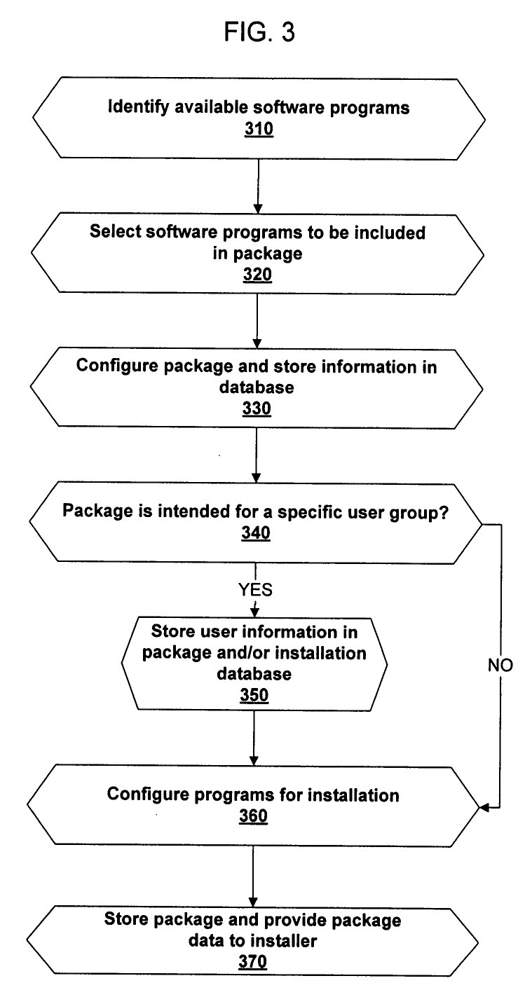

FIG. 3 shows a method of creating a software package according to an embodiment of the present invention. A component of a business system, such as an distribution server, may present software applications available on the business system to an administrator 310. The administrator may select software applications from those available on the business system to include in a multi-product package 320. For example, an administrator may select those applications used for a specific type of task, such as applications used for sales-related activities. Applications may also be selected, for example, based on the type of user that will install the application, the user role or department for which the software package is intended, or other criteria selected by an administrator. After the applications are selected 320, a multi-product package containing the selected applications may be created 330. The package may include, for example, a list of the applications selected, configuration data for each application, and other data that may be used when installing each application on a user workstation.

An administrator may indicate that a software package is intended for use by a specific user group, type, access level, etc., 340. If the package is intended for such a purpose, information designating the user, user group, or other intended use of the package may be stored. For example, the information may be stored in a package installation database on a distribution or installation server. When a user later indicates that software applications are to be installed on a user workstation, the distribution server may use the stored information to determine which packages should be presented to the user for installation. For example, if the package is intended for use only by a specific group of users, the distribution server may present the package to only those users that are members of the group. Alternatively, an distribution server may present a list of all packages stored in the system, and only allow installation of various packages by those users who are members of a group associated with each package. Other constraints may be enforced by the installation system.

In some cases, software applications may use or require additional configuration data when installed on a user workstation. For example, an application may provide various installation options, such as various user interfaces that may be used. An application may also require information such as the location on a target workstation to which the application should be installed. When an administrator selects an application to be included in a software package, the administrator may specify such information 360. The complete package may then be stored in the business system such as on a distribution server 370. A user may later indicate that software applications are to be installed on a user workstation, for example, by running an installation application on the workstation. In response, the distribution server can provide application and configuration data to the user workstation or an installation application running on the workstation 370.

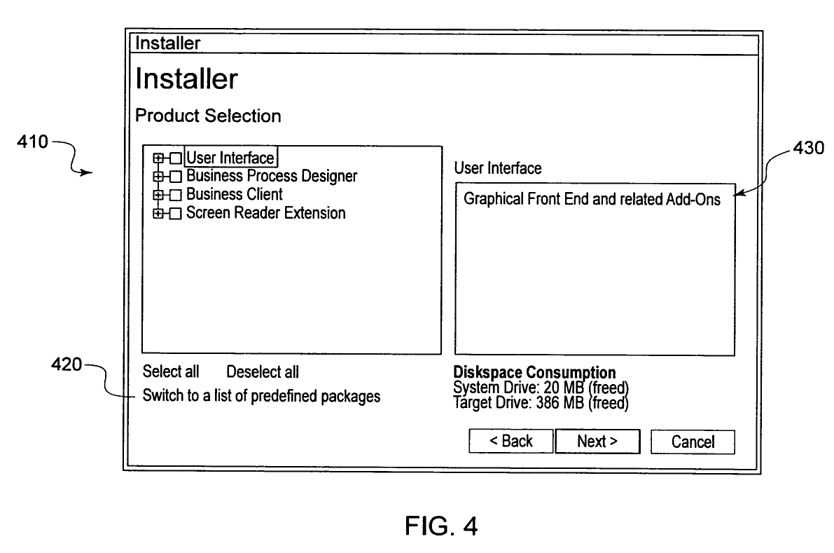

FIG. 4 shows an example of a user interface for an installation application program run on a workstation by a user. A list of applications 410 that can be installed on the workstation may be displayed to the user. When a user selects one of the applications, a description of the selected application may be displayed 430. If a user wants to install an application, the user may indicate the application to be selected by selecting the checkbox shown next to each application. The interface may include an option 420 to display application packages available on the system. If a user selects this option, the interface may display the previously-configured packages instead of individual applications that are available on the system.

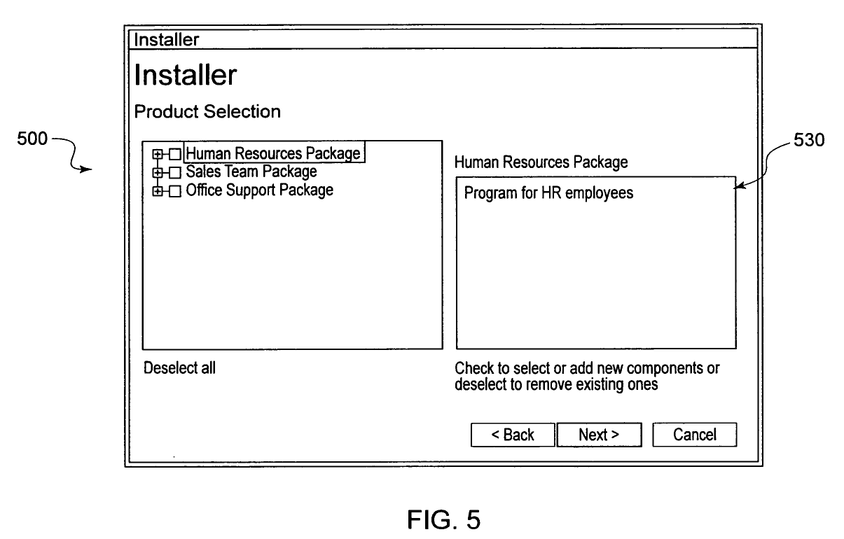

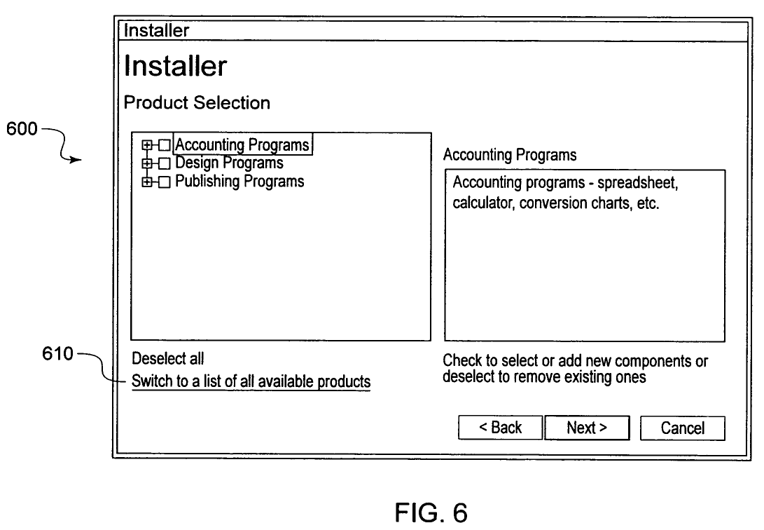

FIG. 5 shows another example of a user interface according to an embodiment of the present invention. The interface may include a list of packages 500 available to install on the workstation. The interface includes multiple application packages intended for use, for example, by human resources employees, sales employees, and/or office support employees 530. Each package may include some or all of the same applications as one or any of the other packages or each package may include applications not included in any other listed packages. An administrator or another may be provided with this screen in order to create one or more packages. Upon creation of the package(s), an administrator may need to supply customizing information for each application (or part thereof) included in each package. The customizing information may be a destination address for each application. FIG. 6 shows another example of a user interface. Packages 600 are organized based on the type of application included in each package. In the example shown, packages are displayed that include applications directed to accounting, design, and publishing. A user may select one, some, or all of the packages based on the types of programs desired to install on a workstation. Or, a user may be provided access to, or even see only one package to install for that specific user. For example, a user in the Sales Team may only be provided with the option to select and download the Sales Team software package. On the user interface, the user may be allowed to see other software packages available—even if only to others and not the user—or the user may see only those software packages for which the user is authorized to download. Further, the user is able to click on the software package and view the products included in the package before downloading. Each of the user interfaces according to embodiments of the invention may also include an option to re-display all the applications available in the system 610.

In embodiments of the present invention, parts thereof of an application or software product may be one or more components. A component, or installation component, may include file(s), registry key(s), script, etc. An action can install a component. A UI layer, for example, may be a collection of actions. Installation of a component effects an installation of everything included in that product component, which may include multiple files and registry keys. Likewise, uninstallation of a component effects an uninstallation of everything included in the product component. In an embodiment, when a request is made to delete a product, a check is done to see if an installation component of the product is used by another product and if not, the product may be deleted. An administrator may or may not request to remove a component of a product, but rather the product in its entirety. In the present invention, if a product component is a part of a package, then all of its files, registry keys script, etc. are a part of the package.

In each of the exemplary user interfaces shown in FIGS. 4, 5, and 6, when a user selects the “Next” button, an installation of the selected application or packages may be made on the workstation. If selected packages are unavailable to the user, an error message may be displayed. Alternatively, as discussed above, the unavailable packages may not be displayed in the user interfaces shown in FIGS. 4, 5, and 6.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method of creating a software package for installation on a workstation, comprising:
identifying applications available on a server for distribution to the workstation;
selecting at least two identified applications via a graphical user interface;
associating the at least two identified applications to form the software package;
installing the software package on the workstation, wherein the at least two identified applications are installed on the workstation as a result of a single request.

2. The method of claim 1, wherein one of an administrator and a user requested the installation of the software package.

3. The method of claim 2 further comprising:
supplying information for customizing the installation of each of the at least two identified applications by the one of an administrator and a user.

4. The method of claim 1 further comprising:
storing configuration data in the software package.

5. The method of claim 4, further comprising:
associating a user access security to the software package so that only authorized users may install the software packages wherein the user access security is stored as configuration data.

6. A method of installing a set of applications on a user workstation, comprising:
presenting a list of applications available on an installation server to an administrator; and
responsive to a selection of at least two of the applications by the administrator, adding the application to a software package identified by the administrator;
storing the software package on a distribution server;
responsive to selection of the software package by a user, installing all applications associated with the software package on the user workstation.

7. The method of claim 6, further comprising:
associating the software package with a specific user group prior to storing the software package on the distribution server.

8. The method of claim 7, wherein the application is installed only if the user selecting the package is a member of the specific user group.

9. The method of claim 8, further comprising:
requesting the application administrator to supply customizing information when adding the application to the software package identified by the administrator.

10. The method of claim 9, wherein the customizing information is a location address of where the application should be installed on the user workstation

11. The method of claim 9, wherein the customizing information includes at least one of a location address, a proxy address, a user name, and a password.

12. A computer-readable medium storing instructions for execution by a processor, which when executed by the processor perform:
identifying applications available on a server for distribution to a workstation;
associating at least two identified applications to form a software package;
installing the software package on the workstation, wherein the at least two identified applications are installed on the workstation as a result of a single request.

13. The method of claim 12, wherein one of an administrator and a user requested the installation of the software package.

14. The method of claim 12, further comprising:
storing configuration data in the software package.

15. The method of claim 14, further comprising:
associating a user access security to the software package so that only authorized users may install the software package, wherein the user access security is stored as configuration data.

16. The method of claim 15, further comprising:
requesting supplication of an installation destination address on the workstation, wherein the installation destination address is stored as configuration data.
